(19) United States
(12) Patent Application Publication
(10) Pub. No.: US 2017/0098880 A1
(43) Pub. Date: Apr. 6, 2017

(54) REDUCTION OF VARIATIONS IN COUPLING OF DIFFERENTIAL STRIPLINES

(71) Applicant: FUJITSU LIMITED, Kawasaki-shi (JP)

(72) Inventor: Yasuo HIDAKA, Cupertino, CA (US)

(21) Appl. No.: 14/874,075

(22) Filed: Oct. 2, 2015

(51) Int. Cl. H05K 1/02; H01P 3/08; H01P 11/00

(52) U.S. Cl. CPC H01P 3/08; H01P 11/001; H01F 38/14; H01F 2038/146

(57) ABSTRACT

A circuit board may include a first trace and a second trace that may be broadside coupled between a first ground plane and a second ground plane. The circuit board may also include a first dielectric material disposed between the first trace and the second trace. The first dielectric material may include a first weave pattern and the first trace and the second trace may be rotated with respect to a first orientation of the first weave pattern. Further, the circuit board may include a second dielectric material disposed between the first trace and the first ground plane and disposed between the second trace and the second ground plane. A difference between a first dielectric value of the first dielectric material and a second dielectric value of the second dielectric material may suppress a mode conversion of a differential signal.

### FIELD

The embodiments discussed in the present disclosure are related to compensating for intra-pair skew in differential signaling.

### BACKGROUND

A differential signal typically includes two separate signals that are sent along two different signal paths. Information is read from and written to a differential signal based on comparisons between the two separate signals. The two different signal paths traversed by the two signals in a differential signal may be separate traces on or in a circuit board. The two signals in a differential signal, however, may not propagate at the same speed due to non-uniformities in the materials surrounding the traces, which may cause intra-pair skew between the two signals of the differential signal. Intra-pair skew may result in degradation and/or loss of a differential signal.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a circuit board may be configured to reduce electrical signal degradation. The circuit board may include a first ground plane and a second ground plane. The circuit board may also include a first trace disposed between the first ground plane and the second ground plane. The first trace may be configured to carry a first signal of a differential signal. The circuit board may also include a second trace disposed between the first trace and the second ground plane. The second trace may be substantially parallel to the first trace and may have at least a portion thereof substantially aligned with the first trace. The second trace may also be configured to carry a second signal of the differential signal. The circuit board may also include a first dielectric material disposed between the first trace and the second trace that has a first dielectric value. The first dielectric material may have a first weave pattern oriented with respect to the first trace and the second trace such that the first trace and the second trace are rotated with respect to a first orientation of the first weave pattern. Further, the circuit board may include a second dielectric material disposed between the first trace and the first ground plane and disposed between the second trace and the second ground plane. The second dielectric material may have a second dielectric value different from the first dielectric value. A difference between the first dielectric value and the second dielectric value may be large enough to create capacitive or inductive coupling between the first and second traces. Such coupling may suppress a mode conversion of the differential signal from a differential mode to a common mode.

The objects and advantages of the embodiments will be realized and achieved at least by the elements, features, and combinations particularly pointed out in the claims.

It is to be understood that both the foregoing general description and the following detailed description are given as examples, are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates a cross section of an example circuit board configured to compensate for intra-pair skew that may be experienced by a differential signal;

FIG. 2 illustrates an example embodiment of a circuit board with a PCP stack configuration;

FIG. 3 illustrates an example embodiment of a circuit board with a CPC stack configuration;

FIG. 4 illustrates an example orientation of a differential stripline on a circuit board;

FIG. 5 is a flowchart of an example method of modeling a circuit board configured to reduce electrical signal degradation; and

FIG. 6 is a flowchart of an example method of forming a circuit board configured to reduce electrical signal degradation.

### DESCRIPTION OF EMBODIMENTS

As explained in detail below, a circuit board may be configured to compensate for intra-pair skew that may be experienced by a differential signal. Intra-pair skew may be caused by the two signals of a differential signal propagating at different speeds. The intra-pair skew may result in signal degradation of the differential signal. For example, when two signals of a differential signal propagate at significantly different speeds, they may become out of phase with each other such that the differential signal may change modes, e.g., changing from a differential mode to a common mode. The change from a differential mode to a common mode may result in loss of the information carried by the differential signal. Mode conversion caused by intra-pair skew typically increases as the frequencies of differential signals are increased. Accordingly, intra-pair skew may limit maximum data rates that may be obtained for differential signals.

According to some embodiments described in the present disclosure, a circuit board configured to compensate for intra-pair skew may include a first trace configured to carry a first signal of a differential signal. The circuit board may also include a second trace configured to carry a second signal of the differential signal. The first trace may be disposed between a first ground plane of the circuit board and the second trace and the second trace may be disposed between the first trace and a second ground plane of the circuit board. Accordingly, the first and second signals may be disposed on different layers of the circuit board. Additionally, the first and second traces may be substantially parallel to each other and may have at least a portion thereof substantially aligned with each other such that the first trace and the second trace may be broadside coupled.

The circuit board may further include a first dielectric material having a first dielectric value and a second dielectric material having a second dielectric value different from the first dielectric value. The first dielectric material may be disposed between the first trace and the second trace and the second dielectric material may be disposed between the first trace and the first ground plane as well as between the second trace and the second ground plane. The first and second dielectric values may be configured such that the difference between them may create capacitive or inductive coupling (generally referred to as “coupling”) between the first and second traces. The amount of coupling may help compensate for intra-pair skew between the first and second signals, which may suppress a mode conversion of the differential signal to maintain a differential mode of the differential signal. The mode-conversion suppression may be maintained over wide frequency ranges of the differential signal such that the data rate of the differential signal may be increased for the circuit board as compared to other circuit boards that do not incorporate the teachings described in the present disclosure.

In some embodiments, the first dielectric material and the second dielectric material may each include a fiberglass material that may include weaved glass threads. Fiberglass material that includes weaved glass threads may also be referred to as “glass cloth” in the present disclosure. Further, the first dielectric material and the second dielectric material may include resin that may be disposed between and around the weave of the glass cloth. The dielectric values of the first and second dielectric materials may vary at different locations depending on the amount of glass and resin at the locations. Further, the amount of glass and resin at the locations may be based on a weave pattern of the corresponding glass cloth.

For example, a first location of a particular dielectric material (e.g., the first or the second dielectric material) that is between glass threads may include little to no glass. In addition, a second location of the particular dielectric material that is at an intersection of glass threads may include a significantly larger amount of glass than the first location. Further, the glass and the resin may have different dielectric values. Therefore, in some instances, the dielectric value of the particular dielectric material at the first location may differ from that at the second location because of the different concentrations of glass and resin between the first and second locations. The differences in dielectric values at different locations along the first and/or second dielectric materials may affect the amount of coupling between the first and second traces at different locations, which may affect the amount of mode-conversion suppression.

According to one or more embodiments of the present disclosure, the first and second traces of the broadside coupled differential striplines may be oriented with respect to orientations of the weave patterns of the first and second dielectric materials such that overall variations in coupling between the first and second traces may be reduced. In particular, in some embodiments and as detailed below, the orientation of the first and second traces may be rotated with respect to orientations of the weave patterns of the first and/or second dielectric materials. As indicated below, rotation of the first and second traces with respect to the weave pattern orientations may create a more even distribution of glass and resin concentrations along the path of the first and second traces, which may reduce overall variations in coupling between the first and second traces. In the present disclosure, reference to an orientation of a trace that is “rotated” with respect to a weave pattern orientation may refer to an orientation in which the trace does not run substantially parallel or substantially perpendicular to the glass threads that create the weave pattern.

Embodiments of the present disclosure will be explained with reference to the accompanying drawings.

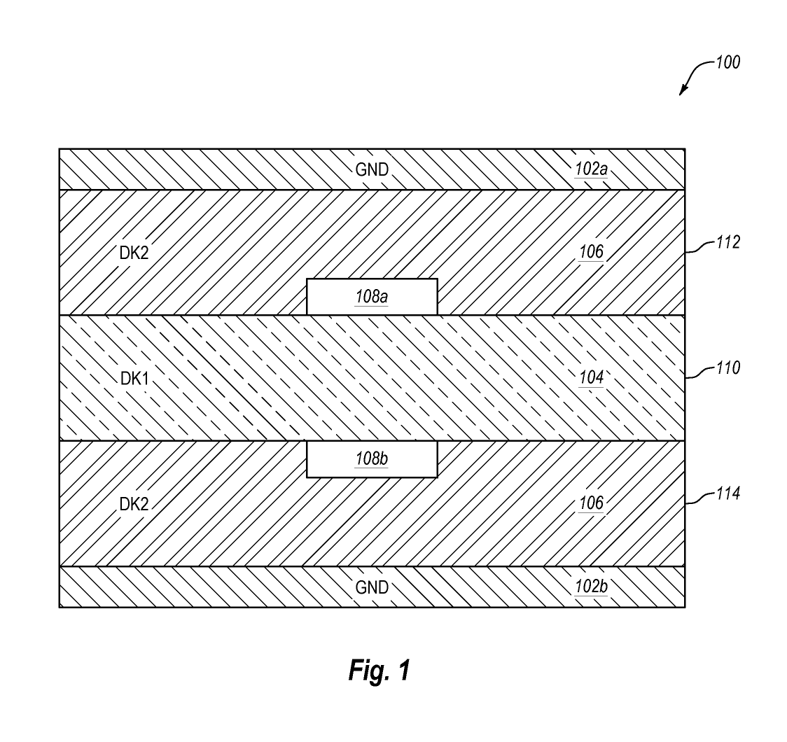

FIG. 1 illustrates a cross section of an example circuit board 100 configured to compensate for intra-pair skew that may be experienced by a differential signal, according to at least one embodiment of the present disclosure. The circuit board 100 may include a layered circuit board such as a Printed Circuit Board (PCB).

In the illustrated embodiment, the circuit board 100 may include a first ground plane 102a and a second ground plane 102b, which may each be associated with different layers of the circuit board 100 such as illustrated in FIG. 1. The ground planes 102a and 102b are labeled as “GND” in FIG. 1 and may include any suitable type of conductor that may cover a substantial portion of their respective layers such that current may pass through the ground planes 102a and 102b.

The circuit board 100 may also include a first trace 108a and a second trace 108b disposed between the first ground plane 102a and the second ground plane 102b. The first trace 108a and the second trace 108b may include any suitable type of conductor configured to carry an electrical current. The first trace 108a and the second trace 108b may be configured as a differential pair such that the first trace 108a may be configured to carry a first signal of a differential signal and the second trace 108b may be configured to carry a second signal of the differential signal.

The first trace 108a and the second trace 108b may be broadside coupled. For example, the first trace 108a may be disposed at a layer of the circuit board 100 and the second trace 108b may be disposed at another layer of the circuit board 100 in a manner such that at least a portion of the second trace 108b is underneath the first trace 108a and runs substantially parallel to the first trace 108a.

The circuit board 100 may also include a first dielectric material 104 and a second dielectric material 106. The first dielectric material 104 may be disposed between the first trace 108a and the second trace 108b in a manner such as that illustrated in FIG. 1 to form a first dielectric layer 110 of the circuit board 100. The second dielectric material 106 may be disposed between the first dielectric material 104 and the first ground plane 102a as illustrated in FIG. 1 to form a second dielectric layer 112. The second dielectric material 106 may also be disposed between the first dielectric material 104 and the second ground plane 102b as illustrated in FIG. 1 to form a third dielectric layer 114.

The first dielectric material 104 may have a first dielectric value (“Dk1”) and the second dielectric material 106 may have a second dielectric value (“Dk2”). The first dielectric material 104 and the second dielectric material 106 may be configured such that the first dielectric value and the second dielectric value differ from each other in a manner that creates a capacitive or inductive coupling between the first trace 108a and the second trace 108b. The coupling may compensate for intra-pair skew and may suppress a mode conversion of differential signals that may propagate along the first trace 108a and the second trace 108b.

In some embodiments, the first dielectric value may be configured to be greater than the second dielectric value, which may create capacitive coupling between the first trace 108a and the second trace 108b. In other embodiments, the first dielectric value may be configured to be less than the second dielectric value, which may create inductive coupling between the first trace 108a and the second trace 108b. The capacitive or inductive coupling may cause the differential-mode components of a differential signal to have a higher gain, over a wide frequency range, than the common-mode components converted from the differential signal. A mode-conversion may become a problem when the gain of the common-mode components converted from the differential signal is greater than the gain of the differential-mode components of the differential signal. Accordingly, the inductive or capacitive coupling may suppress the problem of the mode-conversion over a large frequency range by maintaining a higher gain for the differential-mode components of the differential signal than the common-mode components converted from the differential signal over the large frequency range.

The first dielectric material 104 and the second dielectric material 106 may be configured such that the difference between the first dielectric value and the second dielectric value provides enough capacitive or inductive coupling between the first trace 108a and the second trace 108b to suppress mode conversion of the differential signal while also avoiding large cross-talk within the circuit board 100 that may be caused by too great of a difference between the first dielectric value and the second dielectric value. In some embodiments, the first dielectric value and the second dielectric value may be determined based off of an expression that may represent the reduction of the effect of intra-pair skew in differential signals that may propagate along the first trace 108a and the second trace 108b. The reduction of the effect of intra-pair skew may be referred to as a “Skew Reduction Factor” (“SRF”) and may be represented by the following expression:

SRF=(Dk1−Dk2)/ΔDk.

In the above-expression “SRF” may represent the Skew Reduction Factor; “Dk1” may represent the first dielectric value; and “Dk2” may represent the second dielectric value. Additionally, in the above expression, “ΔDk” may represent a worst deviation in Dk2 or a combination of a worst deviation in Dk1 and Dk2, which may be a factor of the first dielectric material 104 and the second dielectric material 106 not being homogenous materials.

For example, with the first dielectric material 104 and the second dielectric material 106 not being homogenous, the second dielectric value of the second dielectric layer 112 as it relates to the first dielectric value may be different than the second dielectric value of the third dielectric layer 114 as it relates to the first dielectric value. When the first dielectric material 104 is a single-ply material, the first dielectric material 104 may be modeled as being homogenous (even though it may not be) because the first dielectric material 104 and the first dielectric value may be substantially the same from the perspective of the first trace 108a and the second trace 108b. Therefore, “ΔDk” may represent a worst deviation in the second dielectric value between the second dielectric layer 112 and the third dielectric layer 114.

When the first dielectric material 104 is a multi-ply (e.g., 2 or more plies) material, the first dielectric material 104 and associated first dielectric value may be different from the perspectives of the first trace 108a and the second trace 108b. Therefore, “ΔDk” may represent a worst deviation in the first dielectric value between the different plies of the first dielectric material 104 as well as a deviation in the second dielectric value of the second dielectric material 106 of the second dielectric layer 112 and the third dielectric layer 114.

For capacitive coupling, the first dielectric material 104 and the second dielectric material 106 may be configured such that the first dielectric value, the second dielectric value, and the worst deviation “ΔDk” result in a skew reduction factor that is approximately between “1” and “6,” which may provide a sufficient amount of coupling for skew reduction while also avoiding excess cross-talk. For inductive coupling, the first dielectric material 104 and the second dielectric material 106 may be configured such that the first dielectric value, the second dielectric value, and the worst deviation “ΔDk” result in a skew reduction factor that is approximately between “−1” and “−6,” which may provide a sufficient amount of coupling for skew reduction while also avoiding excess cross-talk.

In some embodiments, the amount of coupling used for inductive coupling may be less than the amount of coupling used for capacitive coupling to achieve a target skew-effect reduction while at least partially avoiding pre-cursor ISI (inter-symbol interference). The amount of inductive coupling may be lower because inductive coupling may not cause pre-cursor ISI even when the inductive coupling is relatively weak. In contrast, in some instances, capacitive coupling may cause a significant amount of pre-cursor ISI when the amount of capacitive coupling is relatively weak. Pre-cursor ISI may not be desired because a conventional equalizer may not be able to compensate for a significant amount of pre-cursor ISI.

The capacitive or inductive coupling of differential striplines may be achieved by selecting certain materials with certain properties to achieve the target first dielectric value for the first dielectric material 104 and to achieve the target second dielectric value for the second dielectric material 106. For example, the first and second dielectric values and their deviations may be based on whether their respective dielectric materials are made from a pre-impregnated (“prepreg”) material or a core material. Both the prepreg material and the core material may include a glass cloth that is impregnated with a type of resin. Typically, the core material may include a higher concentration of fiberglass than the prepreg material. Conversely, prepreg material generally includes a higher concentration of resin. The core material may be hardened before a conductor pattern (e.g., a signal trace) may be made on a surface of the core material. The prepreg material may be hardened after being laminated with the core material that is already hardened and has the conductor pattern on its surface. Generally, core material tends to have a higher average dielectric value than prepreg material because glass typically has a higher dielectric value than resin. However, in some instances the types of glass and resin that may be used for particular core and prepreg materials may be such that the average dielectric value of a particular core material may be less than the average dielectric value of a particular prepreg material.

As indicated above, the type of glass or resin used in the core or prepreg may also affect the dielectric values. For example, the glass used in the fiberglass may be E-glass (alumino-borosilicate glass with less than 1% w/w alkali oxides) or NE-glass, which may have different dielectric properties. Similarly, the resin type may affect the dielectric values of the first dielectric material 104 and the second dielectric material 106. For example, the resin type may include a Megtron 6, an FX2, or an FL700 resin type, which may have different dielectric properties.

Additionally, the percentage of resin in the first dielectric material 104 or the second dielectric material 106 may affect the first or second dielectric values, respectively. For example, a dielectric material with a resin percentage of 57% may have a higher dielectric value than a dielectric material with a resin percentage of 77% assuming that the other properties (e.g., glass type, resin type, fiberglass style, etc.) are the same and the dielectric value of the resin is lower than the dielectric value of the fiberglass.

Further, the style of glass cloth used for the fiberglass may also affect the dielectric value of a particular dielectric material. For example, different glass cloths may have different weave patterns, which may affect the dielectric properties. Similarly, the number of plies of the glass cloth may also affect the dielectric properties of the first dielectric material 104 or the second dielectric material 106. For example, the deviation of the second dielectric value of the second dielectric material 106 may be reduced by using a multi-ply (e.g., 2 ply) glass cloth as compared to a single-ply glass cloth because the dielectric effects of the multiple plies may be averaged such that the deviation between the second dielectric value of the second dielectric material 106 of the second dielectric layer 112 and the third dielectric layer 114 may be reduced. Conversely, as mentioned above, the variation of the first dielectric value of the first dielectric material 104 may become non-negligible when a glass cloth of more than one ply is used for the first dielectric material 104 because the first dielectric value may be different from the perspectives of the first trace 108a and the second trace 108b.

In some embodiments, the first dielectric material 104 and the second dielectric material 106 may include a same resin type and in other embodiments the first dielectric material 104 and the second dielectric material 106 may include a different resin type. Using the same resin type may facilitate manufacturing. However, use of the same resin type may also cause weak coupling between the first trace 108a and the second trace 108b at locations of the first trace 108a and the second trace 108b along the first dielectric material 104 and the second dielectric material 106 that may both include a relatively large amount of resin and little to no glass. As detailed below, in some embodiments, the first trace 108a and the second trace 108b may be rotated with respect to the orientations of the weave patterns of the first dielectric material 104 and the second dielectric material 106 to help reduce how often the first trace 108a and/or the second trace 108b may be at locations with little to no glass. As such, the rotation may help reduce coupling problems that may occur when using the same resin type for the first dielectric material 104 and the second dielectric material 106.

In some embodiments, the first dielectric material 104 may include a core material and the second dielectric material 106 may include a prepreg material, which may result in a PCP (Prepreg-Core-Prepreg) stack configuration of the circuit board 100. In other embodiments, the first dielectric material 104 may include a prepreg material and the second dielectric material 106 may include a core material, which may result in a CPC (Core-Prepreg-Core) stack configuration of the circuit board 100.

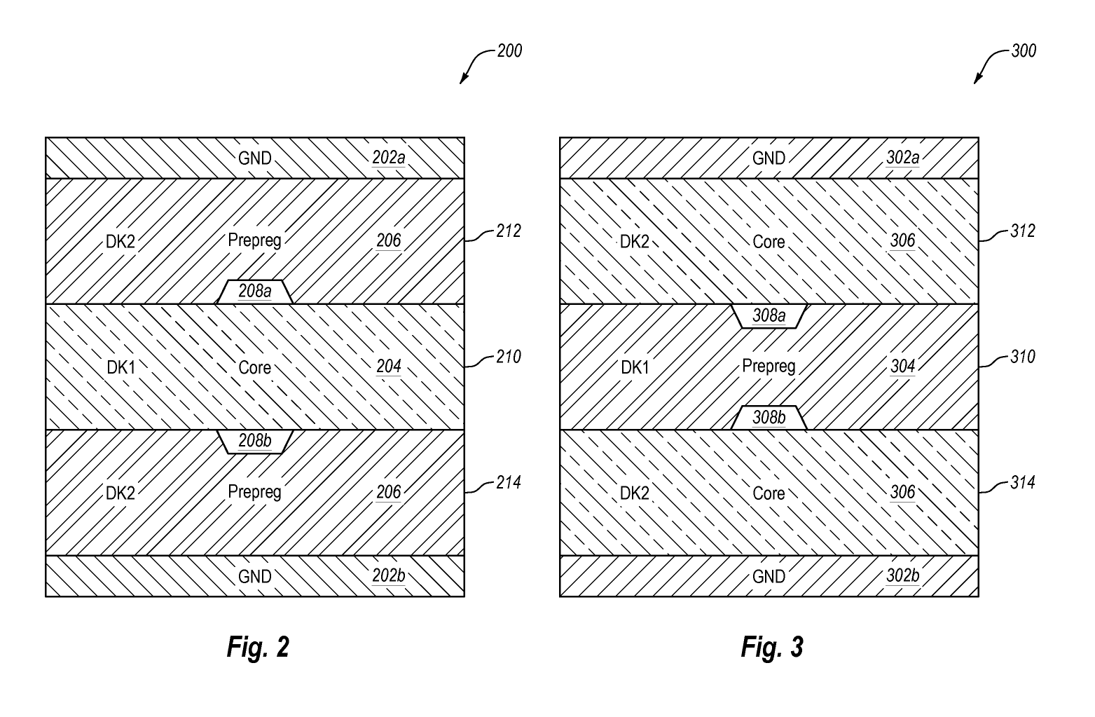

FIG. 2 illustrates an example embodiment of a circuit board 200 with a PCP stack configuration, according to at least one embodiment described in the present disclosure. The circuit board 200 may include a first ground plane 202a, a second ground plane 202b, a first dielectric material 204 forming a first dielectric layer 210, a second dielectric material 206 forming a second dielectric layer 212 and a third dielectric layer 214, a first trace 208a, and a second trace 208b that may be analogous to the first ground plane 102a, the second ground plane 102b, the first dielectric material 104, the first dielectric layer 110, the second dielectric material 106, the second dielectric layer 112, the third dielectric layer 114, the first trace 108a, and the second trace 108b, respectively, of FIG. 1. As illustrated, in FIG. 2, the first dielectric material 204 may include a core material and the second dielectric material 206 may include a prepreg material such that the circuit board 200 may have a PCP stack configuration.

FIG. 3 illustrates an example embodiment of a circuit board 300 with a CPC stack configuration, according to at least one embodiment described in the present disclosure. The circuit board 300 may include a first ground plane 302a, a second ground plane 302b, a first dielectric material 304 forming a first dielectric layer 310, a second dielectric material 306 forming a second dielectric layer 312 and a third dielectric layer 314, a first trace 308a, and a second trace 308b that may be analogous to the first ground plane 102a, the second ground plane 102b, the first dielectric material 104, the first dielectric layer 110, the second dielectric material 106, the second dielectric layer 112, the third dielectric layer 114, the first trace 108a, and the second trace 108b, respectively, of FIG. 1. As illustrated, in FIG. 3, the first dielectric material 304 may include a prepreg material and the second dielectric material 306 may include a core material such that the circuit board 300 may have a CPC stack configuration.

In some instances, the PCP stack configuration of the circuit board 200 may allow for increased impedance control over the CPC stack configuration of the circuit board 300. For example, the alignment of the traces may affect the impedance of and between the traces. The traces 208a and 208b may be etched on the same core material (e.g., the first dielectric material 204 of the first dielectric layer 210) in the PCP stack configuration of the circuit board 200 such that alignment of the traces 208a and 208b may be fairly precise. In contrast, the traces 308a and 308b in the CPC stack configuration may be etched on different core materials (e.g., the second dielectric material 306 of the second dielectric layer 312 and the second dielectric material 306 of the third dielectric layer 314) that may be laminated to the first dielectric layer 310, which may introduce an increased chance that the traces 308a and 308b are not aligned as target.

Additionally, the impedance of and between traces may be affected by the distance between the traces. In the PCP stack configuration of the circuit board 200, the traces 208a and 208b may be separated by a core material, which may be relatively stiff such that the distance between the traces 208a and 208b may be relatively uniform. In contrast, in the CPC stack configuration of the circuit board 300, the traces 308a and 308b may be separated by a prepreg material that may be softer than the core material such that the distance between the traces 308a and 308b may be less uniform. Therefore, the impedance between the traces 308a and 308b of the CPC stack configuration may have more variations than the impedance between the traces 208a and 208b of the PCP stack configuration.

Further, the impedance of and between traces may be affected by the width of the traces. With a constraint to obtain a target impedance, trace width may be a function of the thickness of the dielectric material between the traces such that a thicker dielectric material may allow for wider traces. In the PCP stack configuration of the circuit board 200, the thickness of the first dielectric layer 210 between the traces 208a and 208b may be greater than the thickness of the first dielectric layer 310 between the traces 308a and 308b in the CPC stack configuration of the circuit board 300 because the thickness of the traces 208a and 208b may not be subtracted from the thickness of the first dielectric layer 210 in the PCP stack, whereas the thickness of the traces 308a and 308b may be subtracted from the thickness of the first dielectric layer 310 in the CPC stack. Therefore, to achieve a target impedance in the PCP stack configuration of the circuit board 200, the traces 208a and 208b may be wider than the traces 308a and 308b in the CPC stack configuration of the circuit board 300. Consequently, a target impedance of the traces 308a and 308b of the CPC stack configuration may be harder to obtain than a target impedance of the traces 208a and 208b of the PCP stack configuration because the CPC stack configuration may not allow for as wide of traces as the PCP configuration due to the reduced thickness of the first dielectric layer 310 as compared to the first dielectric layer 210.

The PCP stacking configuration of the circuit board 200 may generally be used for capacitive coupling because, as mentioned earlier, core material may have a higher dielectric value than prepreg material and capacitive coupling may be obtained by having the first dielectric value greater than the second dielectric value. Similarly, the CPC stacking configuration of the circuit board 300 may be used generally for inductive coupling because of the generally higher dielectric value of core material than prepreg material.

However, depending on particular core and prepreg materials that may be selected, in some instances a particular core material may have a lower average dielectric value than a particular prepreg material such that a PCP stacking configuration may be used for inductive coupling or a CPC configuration may be used for capacitive coupling. In these or other embodiments and as described below, the traces may be rotated with respect to the weave pattern orientations of the glass fabric that may be included in the core and/or prepreg materials to help reduce instances at which weak coupling may occur due to little to no glass being around the traces at particular locations.

Accordingly, as described above, the circuit boards 100, 200, and 300 may be configured to produce inductive or capacitive coupling between broadside coupled differential striplines in a manner that may compensate for intra-pair skew and maintain the differential mode of a differential signal over a wide frequency range. Modifications, additions, or omissions may be made to FIGS. 1, 2, and 3 without departing from the scope of the present disclosure. For example, the dielectric values and materials described are given as examples and are not limiting.

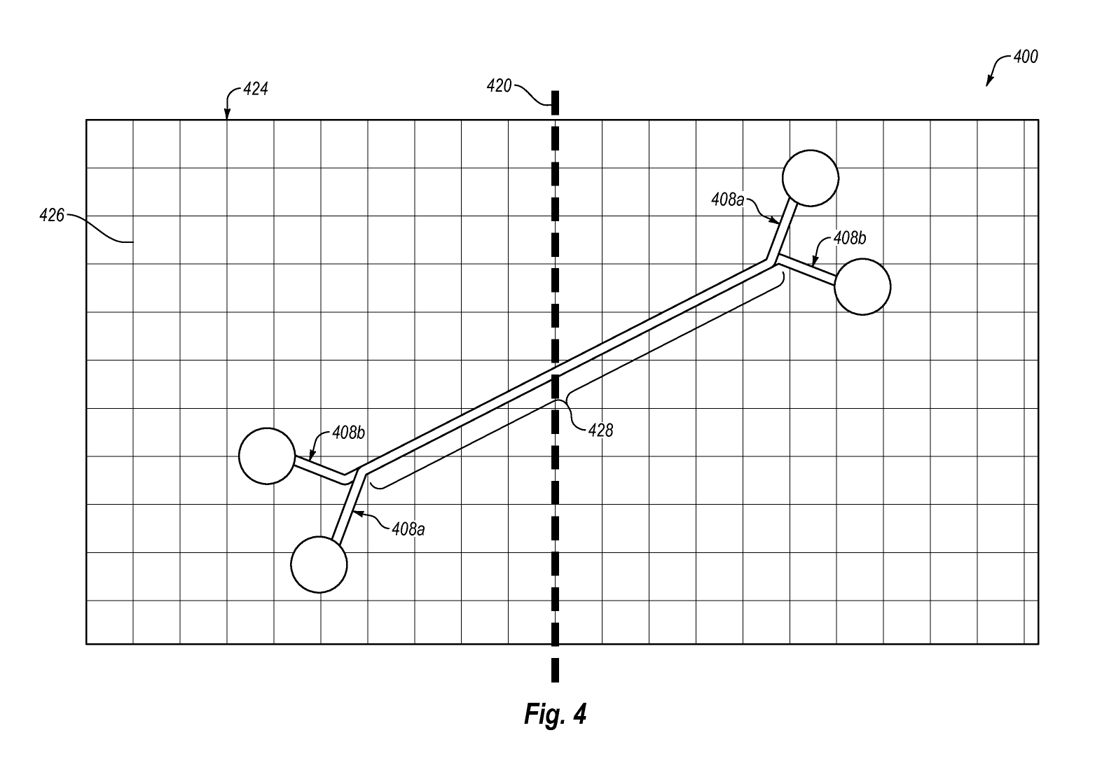

FIG. 4 illustrates an example orientation of a differential stripline on a circuit board 400, according to one or more embodiments of the present disclosure. FIG. 4 illustrates a top-like view of the circuit board 400. In the top-like view of FIG. 4, different elements that may be located at different depths or layers of the circuit board 400 are illustrated. For example, the broadside coupled differential stripline may include a first trace 408a and a second trace 408b that may be located at different depths within the circuit board 400 but that are both depicted in FIG. 4. In addition, the first trace 408a and the second trace 408b may be substantially parallel to each other at different depths (as discussed above) along a portion 428 of the differential stripline such that the first trace 408a and the second trace 408b may be broadside coupled along the portion 428 and such that both may not be depicted along the portion 428 in FIG. 4 due to the top-like view of FIG. 4. Further, FIG. 4 also illustrates a weave pattern 424 that may be associated with a first dielectric material or a second dielectric material of a first, second, or third dielectric layer, which may be at different depths than the first trace 408a and the second trace 408b. By way of example, the circuit board 400 may be configured analogously to the circuit board 200 of FIG. 2 such that the cross-sectional view of FIG. 2 may illustrate a cross-sectional view of the circuit board 400 along a line 420.

The weave pattern 424 may represent a weave pattern of a glass cloth of the first dielectric material or of the second dielectric material. The weave pattern 424 may include multiple glass threads 426 (“threads 426”) that may include multiple first threads and multiple second threads. The first threads may be substantially parallel to each other and the second threads may be substantially parallel to each other and substantially perpendicular to the first threads such that the threads 426 form the weave pattern 424 with a generally rectangular configuration as illustrated. The distances between the threads 426 may be referred to as “pitch” in some instances.

In some embodiments, the traces 408 may be rotated with respect to an orientation of the weave pattern 424 along at least the portion 428 of the differential stripline. Reference of “rotation” of the traces 408 with respect to the orientation of the weave pattern 424 may refer to orientation of the traces 408 with respect to the orientation of the weave pattern 424 such that the paths of the traces 408 intersect the threads 426 of the weave pattern 424 at non-zero or non-perpendicular angles, such as illustrated in FIG. 4. By way of example, the traces 408 may be oriented along the portion 428 such that their paths intersect the threads 426 at angles between 20° and 70° in some embodiments. Note that a 20° intersection with a particular thread that runs one direction may also create a 70° intersection with another thread that runs substantially perpendicular to the particular thread.

In some embodiments, the angles may be selected based on the wavelength of the maximum frequency of the signal and the pitch of the weave. For example, a larger pitch and/or a more shallow angle may result in longer distances between where the differential stripline crosses the weave pattern as opposed to a smaller pitch and/or a less shallow angle. Further, signal degradation may be reduced better in instances in which the distances between where the differential stripline crosses the weave pattern are reduced. As such, the angles may be selected based on the pitch such that the differential stripline crosses the weave pattern at a minimum target distance. Additionally or alternatively, the distance between crossings may need to be smaller for smaller wavelengths. As such, the angles may also be selected based on the wavelength of the maximum frequency such that the distance allows for a target amount of degradation reduction.

The rotation of the traces 408 with respect to the orientation of the weave pattern 424 may help average out coupling variations that may be due to variations in dielectric values of the corresponding dielectric materials that may be caused by different concentrations of glass and resin at different locations of the dielectric materials. The averaging out of coupling variations may improve the overall coupling as opposed to having the traces 408 run substantially parallel or perpendicular to the threads 426. As such, the rotation of the traces 408 with respect to the orientation of the weave pattern 424 may also help reduce mode conversion by helping maintain a target coupling along the path of the traces 408.

In addition, as mentioned above, the rotation of the traces 408 with respect to the orientation of the weave pattern 424 may help with coupling in instances where the same resin type is used for first and second dielectric materials by reducing how often the traces 408 may be at locations with little to no glass.

Although a single weave pattern is illustrated in FIG. 4, the circuit board 400 may include any number of weave patterns depending on the number of plies that may be included in the first or second dielectric material. Additionally, the first dielectric material and the second dielectric material may have weave patterns that may differ with respect to the locations of their respective threads along the circuit board 400. Additionally or alternatively, the pitches of different weave patterns may vary.

In some embodiments, the orientations of different weave patterns may be substantially the same with respect to each other. For example, first threads of a first weave pattern may run substantially parallel to the first threads of a second weave pattern and second threads of the first weave pattern may run substantially parallel to second threads of the second weave pattern. In these embodiments, the traces 408 may be rotated with respect to the orientations of each of the weave patterns due to the orientation of the weave patterns being substantially the same.

In these or other embodiments, the rotation of the traces 408 with respect to the orientation of the weave pattern 424 may also help allow for a multi-ply first dielectric material to be used for a first dielectric layer that may be disposed between second and third dielectric layers of a second dielectric material. As noted above, in some instances a first dielectric value of the first dielectric material may be different from the perspectives of the traces 408 when a multi-ply first dielectric material is used for the first dielectric layer. However, the averaging out of the couplings by the rotation of the traces 408 with respect to corresponding weave pattern orientations may also average out the instances in which the first dielectric value differs from the perspectives of the traces 408.

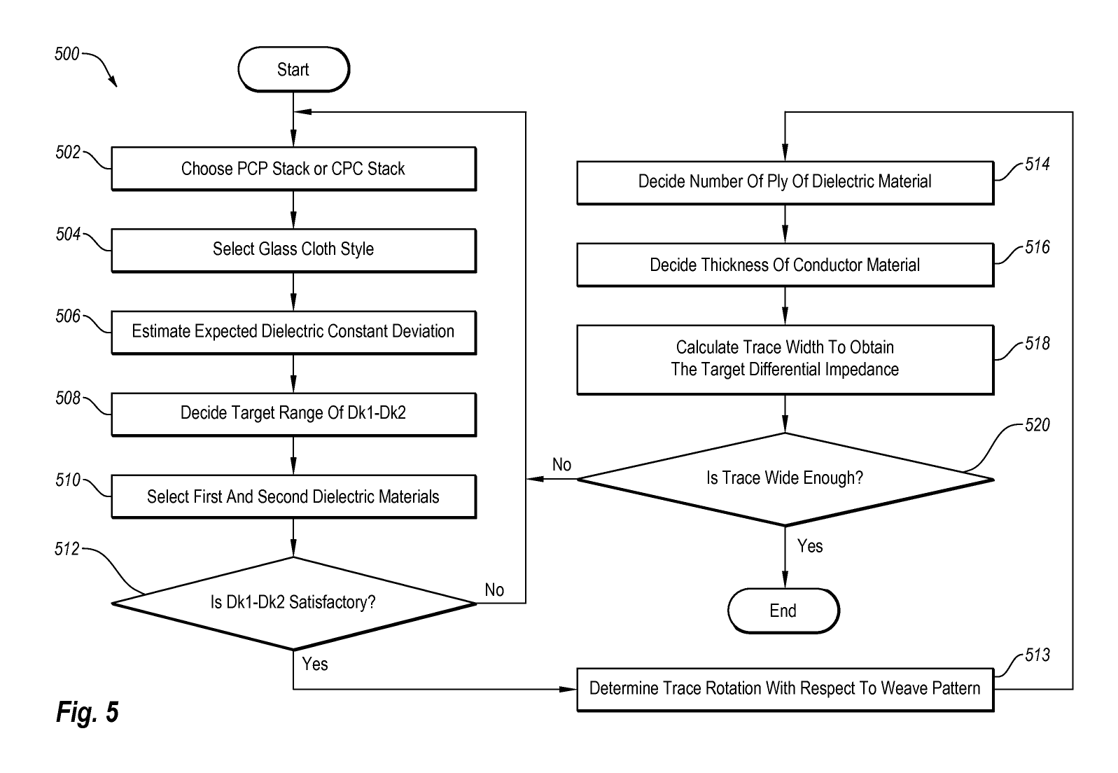

FIG. 5 is a flowchart of an example method 500 of modeling a circuit board configured to reduce electrical signal degradation, arranged in accordance with at least one embodiment described in the present disclosure. The method 500 may be implemented, in some embodiments, using any applicable design software stored on a computer-readable storage medium according to the principles described above with respect to the circuit boards 100, 200, and 300 of FIGS. 1, 2, and 3, respectively. Although illustrated as discrete blocks, various blocks may be divided into additional blocks, combined into fewer blocks, or eliminated, depending on the target implementation.

Accordingly, the method 500 may be used to model a circuit board that includes a first dielectric material forming a first dielectric layer such as the first dielectric materials 104, 204 and/or 304 forming the first dielectric layers 110, 210, and 310, respectively, described above with respect to FIGS. 1, 2, and 3. The modeled circuit board may also include a second dielectric material forming a second dielectric layer and a third dielectric layer such as described above with respect to the second dielectric materials 106, 206, and/or 306, the second dielectric layers 112, 212, and/or 312, and the third dielectric layers 114, 214, and/or 314 of FIGS. 1, 2, and 3. Further, the modeled circuit board may include first and second traces configured such as the first and second traces 108a and 108b, 208a and 208b, and 308a and 308b described above with respect to FIGS. 1, 2, and 3.

The first and second traces may be configured as a differential broadside coupled stripline and the method 500 may be used to configure the first and second dielectric materials such that the first and second traces may be a capacitively or inductively coupled differential broadside-coupled stripline in a manner that may compensate for intra-pair skew. Although illustrated as discrete blocks, various blocks may be divided into additional blocks, combined into fewer blocks, or eliminated, depending on the target implementation.

The method 500 may begin at block 502 where a PCP stack configuration or a CPC stack configuration may be chosen for a layered circuit board. The selection of the PCP stack configuration or CPC stack configuration may be based on any number of factors such as whether capacitive or inductive coupling is targeted for the differential broadside-coupled stripline and the amount of coupling and impedance control targeted.

At block 504, a style of glass cloth may be selected for the fiberglass of the first dielectric material of the layered circuit board and for the fiberglass of the second dielectric material of the layered circuit board. In some embodiments, the style of glass cloth may be the same for the first dielectric material and the second dielectric material or the style of glass cloth may be different. Additionally, in some embodiments, the styles may be selected based on weave patterns of the glass cloths. Example weave patterns that may be used are #1035 and #2116.

At block 506, an expected dielectric value deviation (e.g., “ΔDk” described above) may be determined based on the selected glass cloth style. At block 508, a target range of a difference between a first dielectric value (“Dk1”) of the first dielectric material and a second dielectric value (“Dk2”) of the second dielectric material may be determined. For example, a target range of “Dk1-Dk2” that may be associated with capacitive or inductive coupling may be determined at block 508. Additionally or alternatively, the target range of “Dk1-Dk2” may be determined based on the SRF expression described above.

At block 510, the first dielectric material and the second dielectric material may be selected. The first and second dielectric materials may be chosen based on the target range of “Dk1-Dk2” and/or the glass cloth style selected. For example, the first dielectric material and the second dielectric material may be selected based on dielectric properties that may allow for the target range of “Dk1-Dk2” determined at block 508.

At block 512, after selecting the materials it may be determined whether the selected materials for the first dielectric material and the second dielectric material yield a value of “Dk1-Dk2” that is within the target range of “Dk1-Dk2.” When the value of “Dk1-Dk2” is not within the target range, the method 500 may return to block 502. When the value of “Dk1-Dk2” is within the target range, the method 500 may proceed to block 513.

At block 513, a rotation angle of the first and second traces with respect to the orientations of the weave patterns of the first dielectric material and/or of the second dielectric materials may be determined. In some embodiments, the rotation angle may be determined such that the paths of the first and second traces intersect the glass threads of the weave patterns at non-zero or non-perpendicular angles. In some embodiments, the rotation angle may be determined to be between 20° and 70° with respect to the glass threads of the weave patterns.

At block 514, a ply number for the glass cloth of the materials for the first dielectric material and the second dielectric material may be determined. As mentioned above, in some instances the ply number selected for the first dielectric material may be one and the ply number for the second dielectric material may be more than one to reduce the deviation in dielectric value (“ΔDk”).

At block 516, a thickness of conductor material that may be used for the first and second traces may be determined. The thickness may be selected based on a target differential impedance between the first and second traces. At block 518, a width may be determined for the first and second traces to obtain the target differential impedance between the first and second traces. At block 520, it may be determined whether the first and second traces are wide enough to obtain the target differential impedance. When the traces are wide enough, the method 500 may end. When the traces are not wide enough, the method 500 may repeat.

Modeling a circuit board according to the method 500 may be used to produce a circuit board that may at least partially compensate for intra-pair skew of a differential signal of the circuit board. Modifications may be made to the method 500 without departing from the scope of the present disclosure. For example, the order of the steps associated with the blocks may be performed in a different order than that presented.

The method 500 described in the present disclosure may be implemented using computer-readable media for carrying or having computer-executable instructions or data structures stored thereon. Such computer-readable media may be any available media that may be accessed by a general-purpose or special-purpose computer (e.g., a processor). By way of example, and not limitation, such computer-readable media may include a non-transitory or tangible computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, or any other storage medium which may be used to carry or store target program code in the form of computer-executable instructions or data structures and which may be accessed by a general-purpose or special-purpose computer. Combinations of the above may also be included within the scope of computer-readable media.

Computer-executable instructions include, for example, instructions and data which cause a general-purpose computer, special-purpose computer, or special-purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

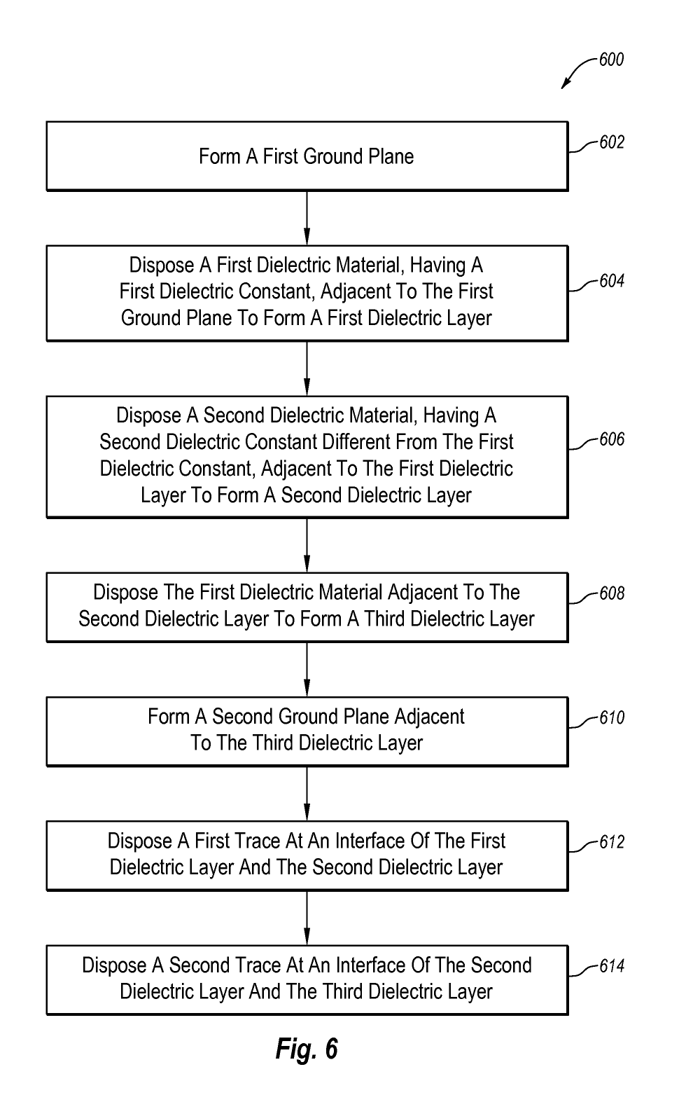

FIG. 6 is a flowchart of an example method 600 of forming a circuit board configured to reduce electrical signal degradation, arranged in accordance with at least one embodiment described in the present disclosure. The method 600 may be implemented, in some embodiments, by forming or manufacturing a layered circuit board according to the principles described above with respect to the circuit boards 100, 200, and 300 of FIGS. 1, 2, and 3, respectively. Although illustrated as discrete blocks, various blocks may be divided into additional blocks, combined into fewer blocks, or eliminated, depending on the target implementation.

The method 600 may begin at block 602 where a first ground plane may be formed. For example, the second ground plane 102b of FIG. 1 may be formed at block 602. At block 604 a first dielectric material may be disposed adjacent to (e.g., in direct contact with) the first ground plane to form a first dielectric layer having a first dielectric value. For example, with respect to FIG. 1, the second dielectric material 106 may be disposed adjacent to and above the second ground plane 102b at block 604 to form the third dielectric layer 114 having the second dielectric value.

At block 606, a second dielectric material may be disposed adjacent to the first dielectric layer formed at block 604 to form a second dielectric layer having a second dielectric value different from the first dielectric value of the first dielectric material disposed at block 604. For example, with respect to FIG. 1, the first dielectric material 104 may be disposed adjacent to the third dielectric layer 114 at block 606 to form the first dielectric layer 110 having the first dielectric value.

At block 608, the first dielectric material disposed at block 604 may be disposed adjacent to the second dielectric layer formed at block 606 to form a third dielectric layer. For example, with respect to FIG. 1, the second dielectric material 106 may be disposed adjacent to the first dielectric layer 110 at block 608 to form the second dielectric layer 112 having the second dielectric value. At block 610, a second ground plane may be formed adjacent to the third dielectric layer formed at block 608. For example, with respect to FIG. 1, the first ground plane 102a may be formed adjacent to the second dielectric layer 112 at block 610.

At block 612, a first trace may be disposed at an interface of the first and second dielectric layers formed at blocks 604 and 606. The first trace may be configured to carry a first signal of a differential signal. For example, with respect to FIG. 1, the second trace 108b may be formed at block 612. At block 614, a second trace may be disposed at an interface of the second and third dielectric layers formed at blocks 606 and 608. The second trace may be substantially parallel to the first trace disposed at block 612 and may have at least a portion thereof substantially aligned with the first trace disposed at block 612. Additionally, the second trace disposed at block 614 may be configured to carry a second signal of the differential signal. For example, with respect to FIG. 1, the first trace 108a may be disposed at block 614.

In some embodiments, the traces disposed at blocks 612 and 614 may be disposed such that they are rotated with respect to orientations of weave patterns of the first and second dielectric material disposed at blocks 604 and 606. In some embodiments, a panel on which the circuit board may be disposed may be rotated at a target angle before disposing the traces such that the traces may be rotated with respect to the orientations of the weave patterns. Additionally or alternatively, the panel may not be moved and the traces may be disposed at the target angle by drawing the traces at the target angle.

A difference between the second dielectric value of the second dielectric layer formed at block 606 and the first dielectric value of the first and third dielectric layers formed at blocks 604 and 608 may suppress a mode conversion of the differential signal such that a differential mode of the differential signal is maintained over a wide frequency range. In some embodiments, the first dielectric value may be greater than the second dielectric value to form an inductive coupling between the first and second traces. In other embodiments, the first dielectric value may be less than the second dielectric value to form a capacitive coupling between the first and second traces. Additionally, in some embodiments, the first and second dielectric values may be configured such that a Skew Reduction Factor discussed above may be less than negative one and greater than negative six for inductive coupling or greater than one and less than six for capacitive coupling. In addition, the rotation of the traces with respect to the orientations of the weave patterns may improve the coupling as discussed above.

Forming a circuit board according to the method 600 may be used to produce a circuit board that at least partially compensates for intra-pair skew of a differential signal of the circuit board. Modifications may be made to the method 600 without departing from the scope of the present disclosure. For example, the order of the steps associated with the blocks may be performed in a different order than that presented. Additionally, in some embodiments, the first dielectric material may include a prepreg material and the second dielectric material may be core material. In other embodiments, the first dielectric material may include a core material and the second dielectric material may include a prepreg material.

Further, in some embodiments, the method 600 may include configuring the first dielectric material to have the first dielectric value based on resin content, type of resin, and/or type of glass material of the first dielectric material. In these or other embodiments, the method 600 may similarly include configuring the second dielectric material to have the second dielectric value based on resin content, type of resin, and/or type of glass material of the second dielectric material.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases at least one and one or more to introduce claim recitations. However, the use of such phrases should not be construed to imply that the introduction of a claim recitation by the indefinite articles “a” or an limits any particular claim containing such introduced claim recitation to embodiments containing only one such recitation, even when the same claim includes the introductory phrases one or more or at least one and indefinite articles such as “a” or an (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A circuit board comprising:
a first ground plane;
a second ground plane;
a first trace disposed between the first ground plane and the second ground plane, the first trace being configured to carry a first signal of a differential signal;
a second trace disposed between the first trace and the second ground plane, the second trace being substantially parallel to the first trace and being substantially aligned with the first trace, the second trace being configured to carry a second signal of the differential signal;
a first dielectric material disposed between the first trace and the second trace and having a first dielectric value and including a first weave pattern oriented with respect to the first trace and the second trace such that the first trace and the second trace are rotated with respect to a first orientation of the first weave pattern; and
a second dielectric material disposed between the first trace and the first ground plane and disposed between the second trace and the second ground plane, the second dielectric material having a second dielectric value different from the first dielectric value, a difference between the first dielectric value and the second dielectric value suppressing a mode conversion of the differential signal from a differential mode to a common mode.

2. The circuit board of claim 1, wherein the first dielectric value is greater than the second dielectric value such that the first trace and the second trace have a capacitive coupling.

3. The circuit board of claim 1, wherein the first dielectric value is less than the second dielectric value such that the first trace and the second trace have an inductive coupling.

4. The circuit board of claim 1, wherein the first dielectric material includes a multi-ply glass cloth.

5. The circuit board of claim 1, wherein the first dielectric material includes a circuit board core material and the second dielectric material includes a circuit board pre-impregnated (“prepreg”) material.

6. The circuit board of claim 1, wherein the first dielectric material and the second dielectric material include a same resin type.

7. The circuit board of claim 1, wherein:
the first dielectric value is represented by “Dk1”;
the second dielectric value is represented by “Dk2”;
a dielectric value worst deviation associated with one or more of Dk1 and Dk2 is represented by “ΔDk”; and
the first dielectric value and the second dielectric value are based on a target skew reduction factor (“SRF) represented by the following expression:
SRF=(Dk1−Dk2)/ΔDk.

8. The circuit board of claim 7, wherein Dk1 and Dk2 are configured such that the SRF is less than negative one and greater than negative six or such that the SRF is greater than one and less than six.

9. The circuit board of claim 1, wherein the first trace and the second trace are rotated between 20° and 70° with respect to the first orientation of the first weave pattern.

10. The circuit board of claim 1, wherein the second dielectric material has a second weave pattern oriented with respect to the first trace and the second trace such that the first trace and the second trace are rotated with respect to a second orientation of the second weave pattern.

11. The circuit board of claim 1, wherein the first dielectric material is configured to have the first dielectric value and the second dielectric material is configured to have the second dielectric value based on one or more of the following included in the first dielectric material and the second dielectric material: resin content, type of resin, type of glass, and weave pattern of the glass.

12. A method of forming a circuit board, the method comprising:
forming a first ground plane;
disposing a first dielectric material adjacent to the first ground plane to form a first dielectric layer having a first dielectric value, the first dielectric material including a first weave pattern;
disposing a second dielectric material adjacent to the first dielectric layer to form a second dielectric layer having a second dielectric value different from the first dielectric value, the second dielectric material including a second weave pattern;
disposing the first dielectric material adjacent to the second dielectric layer to form a third dielectric layer having the first dielectric value;
forming a second ground plane adjacent to the third dielectric layer;
disposing a first trace at an interface of the first dielectric layer and the second dielectric layer, the first trace being configured to carry a first signal of a differential signal and being rotated with respect to an orientation of the first weave pattern and of the second weave pattern; and
disposing a second trace at an interface of the second dielectric layer and the third dielectric layer, the second trace being substantially parallel to the first trace and being substantially aligned with the first trace, the second trace being configured to carry a second signal of the differential signal, a difference between the first dielectric value and the second dielectric value suppressing a mode conversion of the differential signal from a differential mode to a common mode.

13. The method of claim 12, wherein the first dielectric value is greater than the second dielectric value such that the first trace and the second trace have an inductive coupling.

14. The method of claim 12, wherein the first dielectric value is less than the second dielectric value such that the first trace and the second trace have a capacitive coupling.

15. The method of claim 12, wherein the first dielectric material includes a circuit board pre-impregnated (“prepreg”) material and the second dielectric material includes a circuit board core material.

16. The method of claim 12, wherein the second dielectric material includes a multi-ply glass cloth.

17. The method of claim 12, wherein:
the first dielectric value is represented by “Dk1”;
the second dielectric value is represented by “Dk2”;
a dielectric value worst deviation associated with one or more of Dk1 and Dk2 is represented by “ΔDk”; and
the first dielectric value and the second dielectric value are based on a target skew reduction factor (“SRF) represented by the following expression:
SRF=(Dk1−Dk2)/ΔDk.

18. The method of claim 12, further comprising rotating a panel that includes the circuit board before disposing one or more of the following: the first trace and the second trace.

19. The method of claim 12, wherein the first dielectric material and the second dielectric material include a same resin type.

20. The method of claim 12, wherein the first trace and the second trace are rotated between 20° and 70° with respect to the orientation of the first and second weave patterns.
